(19) United States
(12) Patent Application Publication
(10) Pub. No.: US 2020/0065744 A1
(43) Pub. Date: Feb. 27, 2020

(54) Tire counting device and method

(71) Applicant: Robert Allen Crawford, Whittier, CA (US)

(72) Inventor: Robert Allen Crawford, Whittier, CA (US)

(21) Appl. No.: 16/106,844

(22) Filed: Aug. 21, 2018

(51) Int. Cl. G06Q 10/08

(52) U.S. Cl. CPC G06Q 10/087

(57) ABSTRACT

In embodiments, the invention includes an open frame with two uprights and a crossbar. An optical detector senses when tires are rolled through the frame. A controller receives the sense signal from the detector and updates a tire count on a display.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

### Field of the Invention

This invention is in the field of inventory control for tires.

Tires are bulky, expensive, and are available in many varieties, requiring frequent deliveries of tires between stocking and installation locations. During such deliveries, the number of tires transferred frequently does not match the number ordered or billed. Since even a small difference in number may represent significant amounts of money, it is an object of this invention to prevent losses by accurately tallying the number of tires delivered, shipped, or on hand.

Tires are commonly rolled between two operators and tallied during the operation or manually counted. The process is error prone and does not control for deliberate miscounting or diversion of product.

### SUMMARY

In embodiments, the invention includes a device for counting tires. In other embodiments, the invention includes a method of counting tires entering or exiting a vehicle.

In one embodiment, the device of the invention includes a frame including a first upright and a second upright. Each upright has a base and an upper end. The uprights are disposed parallel to one another and are spaced apart. A crossbar connects the upper ends of the uprights. One upright has a light source that projects a light toward the other upright. The second upright has a light detector configured to receive light from the light source. The device also includes a display mounted to the frame and a controller. The controller is electrically coupled to the detector and to the display. The controller is programmed to detect a light signal from the detector and to increment the display upon each detected interruption of the light signal. In some embodiments, the controller includes a wireless data connection to a remote console, which may be a mobile phone or tablet.

In some embodiments, the uprights support the crossbar at a height between about 24 inches and 48 inches. This height may be about 36 inches, and is designed to allow a rolled tire to pass beneath the crossbar, while preventing a human from walking between the uprights, thereby preventing false counts.

In embodiments, the detector may include one or more of an electric eye, a retroreflector, a linear camera, or a 2-D camera. The bases of the uprights may each include one or more wheels. The distance between the uprights may be about six to about nine feet to conform to a loading door on a truck or loading dock. In some embodiments, this distance is about eight feet.

Embodiments of the method of the invention are directed to counting tires entering or exiting a vehicle and include a step of positioning a pair of uprights adjacent opposite sides of a door to a vehicle. One upright includes a light source, and the second upright includes a light detector. The light source produces a light directed toward the light detector. The method also includes steps of rolling a tire between the uprights such that the tire interrupts the light, incrementing a total for each interruption of the light, and displaying the total on a display. In some embodiments, the method includes transmitting the total to a remote console such as a cellular phone, tablet, or computer.

The upright may be connected by a crossbar disposed between 24 and 48 inches above the ground, and the display may be mounted to the crossbar. In embodiments, the uprights each include at least one wheel, and the step of positioning includes rolling the uprights connected by the crossbar adjacent the door.

In some embodiments, the method also includes providing a camera to produce a video record of the counting operation.

### BRIEF DESCRIPTION OF THE DRAWINGS

FIG. 1A shows a perspective view of an embodiment of the device of the invention.

FIG. 1B shows a second perspective view of the embodiment of FIG. 1A.

FIG. 2 shows a block diagram of electrical components of an embodiment of the device.

FIG. 3 shows an embodiment of the device of the invention used in an embodiment of the process of the invention.

FIG. 4 shows a flow chart of an embodiment of the method of the invention.

### DETAILED DESCRIPTION

The invention includes a device and a method. The device includes a frame that fits adjacent a doorway of a truck or other vehicle and has an opening tall enough to permit rolled tires to pass. As each tire passes through, the device detects the tire and increments or decrements a count of the number of tires. A display shows the count during the process.

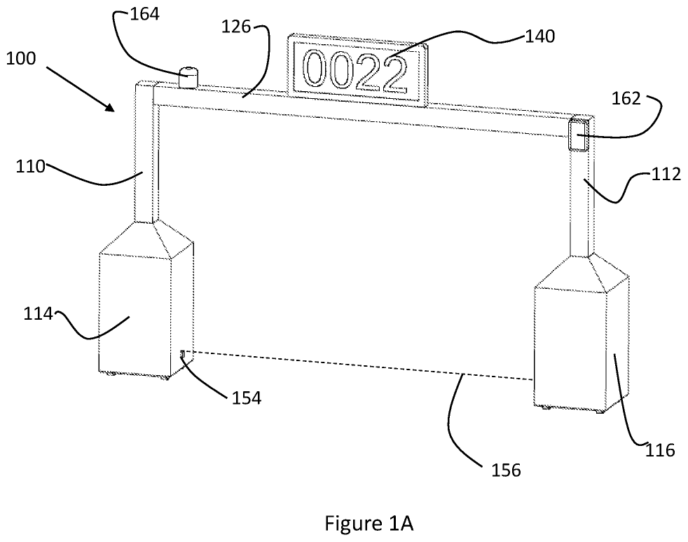

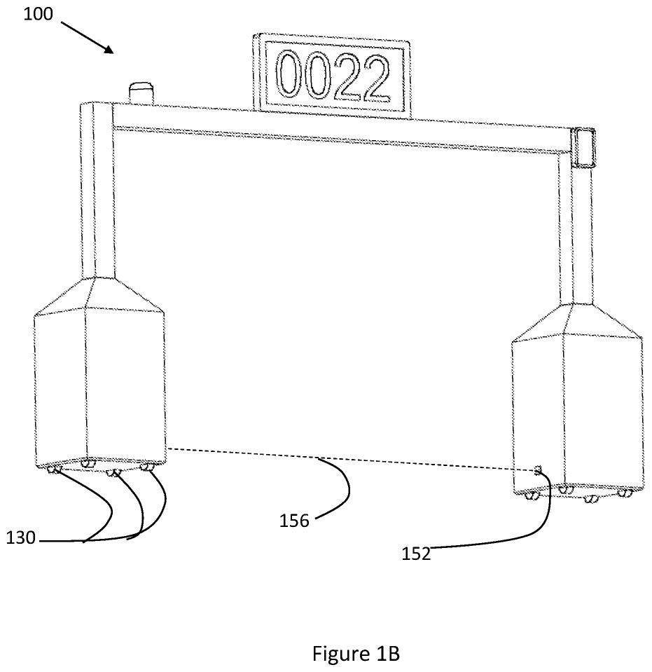

FIGS. 1A and 1B shows tire counting device 100 including paired uprights 110 and 112.

Uprights 110 and 112 are elongated structural members that may be made of any sufficiently strong material. Since the device may be subject to collision by rolling tires while in use, steel is a preferred material.

Each upright 110 and 112 includes a base 114 or 116, an upper end 118 or 120 and an electronics package 122 or 124. Bases 114 and 116 may optionally include wheels 130 to make it easier to position device 100 at its location of use. In some embodiments, each base 114 or 116 includes two or four wheels 130 to provide stability during movement. The wheels 130 may be locking casters to prevent movement during counting operations. In some embodiments bases 114 and 116 may include elevating feet (not shown) that lift wheels 130 or lower bases 114 and 116 to further stabilize the device. In other embodiments, wheels 130 may remain in unlocked contact with the ground so that operators may push device 100 aside in case an emergency arises during tire counting so that an operator may escape past device 100. In such embodiments, device 100 may further be equipped with a motion sensor that senses such movement during counting operations and flags counts where such movement was detected.

A crossbar 126 connects upper ends 118 and 120 to form a rigid structure. Uprights 110 and 112 and crossbar 126 together form a frame that may be moved as a unit and placed as needed adjacent the door of a vehicle or of a warehouse.

Crossbar 126 is positioned parallel to the ground at a height selected to allow tires to be rolled beneath crossbar 126. Crossbar 126 is set sufficiently close to the ground that operators or other humans are discouraged from passing beneath it, which could cause erroneous tire counts or anomalous signals. In some embodiments, crossbar 126 is set at a height of about 24 inches to about 48 inches. The height of crossbar 126 may be about 40 inches. In some embodiments, the height of crossbar 126 may be adjustable to allow use of device 100 with different size tires.

A display 140 is mounted to the frame. In some embodiments, display 130 is mounted to the top of crossbar 126 to afford maximum visibility and to keep out of the way of rolling tires. Display 126 indicates the number of tires that have passed through device 100 during a counting operation. In some embodiments, display 140 may also present additional information, such as whether device 100 has been moved, the time anomalous events (such as movement of device 100, or questionable counts, or counts where tires moved in the reverse of the expected direction) occurred, or other information. Display 140 may be any type of conventional display such as an LED display, an LCD display, or a video monitor.

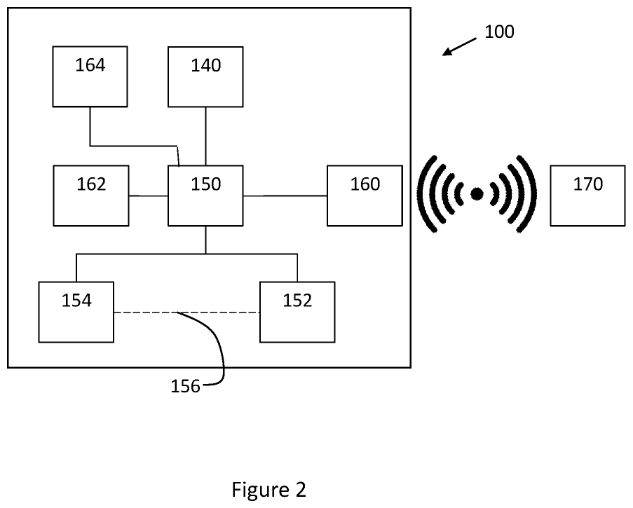

Device 100 further includes additional electronic components including a controller 150, a light source 152, and a detector 154. Optionally, device 100 may also include a wireless transceiver 160. The interconnections among these components (and display 140) is illustrated schematically in FIG. 2. Electronics may be housed in a weather-safe enclosure attached to or comprising any of the uprights, bases, or crossbar. Device 100 also includes power source (not shown), which may be mains powered or battery powered. Conventional wiring or printed circuit boards, or some combination may connect the parts to one another. Device 100 may also include a secure keypad 162 (or port for attaching one) to enter commands or receive status information. Such a keypad may be protected by a physical lock or may require entry of an identification code or biometric identification such as a fingerprint reader. In some embodiments, a light 164 may be affixed to the device 100 to signal the detection of each tire by briefly illuminating as the tire is counted.

Controller 150 controls operation of device 100. Controller 150 may be a microcontroller, such as a single-chip microcontroller such as the PIC 18F25K83 manufactured by Microchip Technology Inc. of Chandler, Ariz. or a board-level microcontroller such as a Raspberry Pi 3 Model B+ single board computer developed by the Raspberry Pi Foundation of the United Kingdom, or the Arduino MKR WiFi 1010 developed by U-BLOX of Thalwil, Switzerland. Alternatively, other commercially available controllers, such as programmable logic controllers or industrial process controllers may serve as controller 150. Controller 150 is programmed to execute a sequence of steps that operate device 100. The programming of electronic devices such as controller 150 is well known in the art. Controller 150 may also include interface electronics such as drivers for display 140, for wireless transceiver 160, and for the tire sensor components as described in more detail below. Controller 150 may also include real time clock functionality to identify the timing of events.

The tire sensor of device 100 comprises light source 152, detector 154, and controller 150. Controller 150 operates the other components to determine whether a tire is traversing device 100. The tire sensor produces one or more light beams 156 that extend between uprights 110 and 112. As an operator roll tires between uprights 110 and 112, each tire interrupts light beam 156. The tire sensor detects this interruption and (after some analysis) produces an indication that a tire has passed through. The analysis may include filtering to remove of flag signals that are too short (perhaps cause by insects or dirt), that are too long (perhaps caused by failure of a light source or by a tire lodged in device 100), or that are too close together (perhaps caused by a light beam encountering leading and trailing sides of a low-profile tire with an intervening open section). The tire sensor may also perform additional analyses to determine the direction a tire is moving or to identify multiple tires passing through device 100 in an overlapping fashion.

Light source 152 is preferably located in one upright of device 100 but may alternatively be located in other positions such as in crossbar 126. Light source 152 may comprise one or more laser diodes, light emitting diodes, or other light sources as are known in the art. These may produce light that is visible or outside the visible range. A visible wavelength advantageously gives a direct indication of operation. A nonvisible wavelength, such as an infrared wavelength, may be more resistant to normal variations in environmental light and may be more readily scattered by tires in embodiments that detect light scattering. Light source 152 produces a light beam 156, which may form a single pencil beam at a fixed height, multiple beams at different positions, or may form a light curtain or fan beam. Light beam 156 may be temporally modulated to reduce the effect of background light or to identify the position of an obstruction (including a transiting tire). Methods for such modulation (and detector-side demodulation) are well known in the art.

An effective detection height of about three inches above the floor is suitable for unambiguously detecting most tires. This may be provided, for example, by a single pencil beam traversing between the uprights.

Detector 154 forms a second major part of the tire sensor of device 100. Detector 154 is preferably located in the opposite upright from light source 152, but, in some embodiments, a single upright may include both light source 152 and detector 154. The opposite upright may include a reflector to return the light beam 156 toward detector 154. Alternatively, the tire sensor may rely on light scattered or reflected by the tire. Embodiments where light source 152 and detector 154 are collocated advantageously reduce the required wiring and circuit boards.

Detector 154 may include any light detector, such as a photodiode, a phototransistor, a photomultiplier tube, a line camera, or a 2-D camera. The ubiquity of 2-D cameras in cellular phones has driven down the cost of such devices and associated drive electronics, advantageously providing greater possibilities for image analysis that may better identify tires in transit. Alternatively, the simplicity of “electric eye” type simple photodetectors can produce a low-cost system that is simple and reliable. Detector 154 may include associated signal processing hardware such as preamplifiers, gain control, modulation/demodulation, analog to digital converters, or digital signal processors as are known in the art.

The purpose of detector 154 is to detect the presence of a tire transiting device 100. In some embodiments, detector 154 detects an interruption in a light beam 156 normally incident on detector 154. In other embodiments, detector 154 detects a scattered light produced by interaction of a passing tire with light beam 156. In still other embodiments, detector 154 forms an image of at least a portion the space between uprights 110 and 112 and determines whether the image includes an image of a tire in transit.

Wireless transceiver 160 may be a conventional radiofrequency communications device such as a Bluetooth®, WiFi, cellular, WAN, or similar system known in the art. In some embodiments, wireless transceiver 160 may use modulated visible or infrared light. Devices of any of these types are well known in the art and are frequently packaged together with controller systems such as single board computers.

The purpose of wireless transceiver 160 is to communicate the progress of a tire transfer to a remote console 170. Controller 150 may send via wireless transceiver 160 information related to the progress of the tire transfer operation. This may include, for example, the then current count of tires, an indication of each detected transfer, the time of each detected transfer, an indication of any anomalous or unexpected signals (such as an extended gap in transfers, an extended light beam interruption, a tire transfer in the reverse direction to that expected (e.g. an unloaded tire during a planned tire loading operation)).

Controller 150 may also send or receive via wireless transceiver 160 commands relative to the operation of device 100. Examples of commands include instructions to reset or change the displayed total count, to correct for an anomalous event (such as a tire stopped between the uprights or mistakenly loaded and then unloaded). Controller 150 may also send or receive via wireless transceiver 160 any additional information, such as status or diagnostic information or information needed to pair device 100 with a particular remote device 170. Pair refers to the establishment of a secure and permitted communication channel between device 100 and remote console 170.

A remote console 170 may be wirelessly coupled to controller 150 through transceiver 160. In some embodiments, remote console 170 may be a desktop PC, display or terminal. In others, remote console 170 may be a cellular phone or tablet. Remote console 170 may be directly wirelessly connected via Bluetooth or similar short-range radio, or it may be connected via a network such a WiFi or cellular network. Portions of the connection may be wired. Communications between wireless transceiver 160 and remote console 170 may be encrypted or otherwise protected to provide for data and operations security.

Remote console 170 may include an application to analyze or review data sent by controller 150. For example, remote console may review the time of counting of each tire as it passes through device 100. Unexpected delays or exceptional rates of counting may suggest additional supervision or analysis is required. For example, if an application on remote console 170 notes a gap in counting at a particular time, the responsible party may advance security video to the time of the gap and review whether tires are being mishandled.

A remote console 170 may be wirelessly connected to more than one tire counting device 100 to monitor multiple transfers in a larger facility. Controller 150 of one device 150 may be wirelessly connected as a hub to other devices 100 to coordinate or transmit cumulative data.

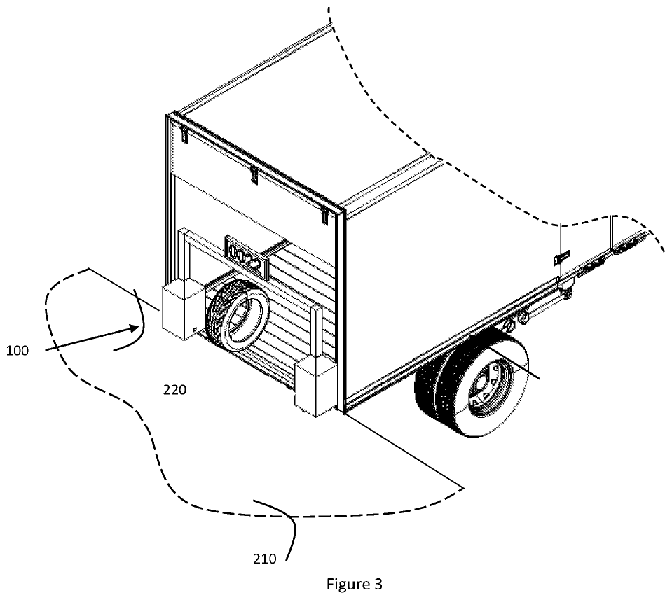

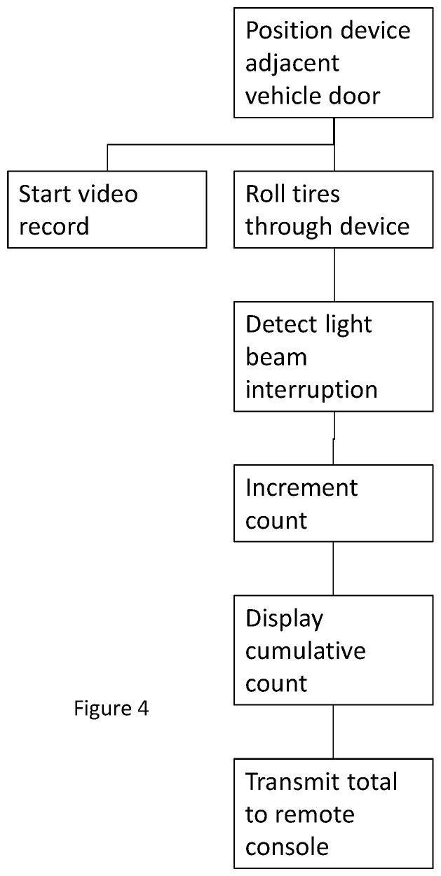

In operation, tire counting proceeds according to the method as illustrated in FIG. 4. An operator first positions the uprights of device 100 adjacent a doorway through which tires are to be rolled for counting. The doorway may be a loading door to a building but is more commonly a door to a truck. In some embodiments, an operator may create a virtual doorway by setting device 100 in an open area of a room or yard for internal inventory operations. FIG. 3 illustrates the device 100 in operating position between a truck 200 and a loading dock 210 of a warehouse. Tire 220 is shown passing through device 100 as it enters truck 200. Display 140 indicates the cumulative count of towers loaded into truck 200.

A pair of operator may then deploy on either side of device 100 and roll tires to be counted through device 100, a process similar to that by which tires are commonly loaded or unloaded without use of the device. The operators sequentially roll each tire between the uprights such that the tire interrupts a light beam. The controller increments a total for each interruption of the light beam and displays the total on the display. In some embodiments, the controller transmits the total to a remote console.

The process may include other steps such as receiving a command from a remote console or via a secure keypad on device 100. Commands may include instructions to start or terminate a loading operation, to reset the display, to clear anomalous signals, or to indicate the desired direction of a tire transfer operation.

In some embodiments, the tire transfer process may be recorded by a suitably placed video camera having a real time clock function. The video camera may be mounted to device 100 but is more commonly a camera that is installed on the premises for routine security operations. This may reduce cost and provide more complete views. The recording may complement the tire counting operation by identifying the cause of anomalous events or of unexpected tire counts. The recording may be advanced to the time of anomalous events as indicated by device 100 or remote console 170 to determine what happened. This advantageously avoids reviewing an entire video record, saving significant time.

This specification discloses various aspects of the invention with reference to particular embodiments, but it should be understood that any of the features, functions, materials, or characteristics may be combined with any other of the described features, functions, materials, or characteristics. The description of particular features, functions, materials, or characteristics in connection with a particular embodiment is exemplary only; it should be understood that it is within the knowledge of one skilled in the art to include such feature, structure, or characteristic in connection with other embodiments whether or not explicitly described. I intend the scope of the appended claims to encompass such alternative embodiments. Variations on these described embodiments will become apparent to those of ordinary skill in the art upon reading the description. The inventor expects skilled artisans to employ such variations as appropriate, and the inventor intends for the invention to be practiced otherwise than specifically described herein. Accordingly, this specification and claims include all modifications and equivalents of the subject matter recited in the claims appended hereto as permitted by applicable law.

Unless otherwise indicated, all numbers used in the specification and claims are to be understood as being modified in all instances by the term “about.” Unless indicated to the contrary, the numerical values in the specification and attached claims are approximations that may vary depending upon the desired properties sought to be obtained.

The terms “a,” “an,” “the” and similar referents used in the context of describing the invention (especially in the context of the following claims) are intended to cover both the singular and the plural, unless otherwise indicated herein or clearly contradicted by context. All methods described herein can be performed in any suitable order unless otherwise indicated herein or otherwise clearly contradicted by context. The use of any and all examples or exemplary language (e.g., “such as”) provided herein is intended merely to better illuminate the invention and does not pose a limitation on the scope of the claims. No language in the specification should be construed as indicating any non-claimed element essential to the practice of the invention.

I claim:

1. A device for counting tires, the device comprising
a frame including
a first upright having a first base and an upper end;
a second upright having a second base and a second upper end, the second upright disposed parallel to the first upright and spaced apart from the first upright;
a crossbar connecting the first upper end to the second upper end;
a light source disposed in the first upright and projecting a light toward the second upright;
a light detector disposed in the second upright and configured to receive light from the light source;
a display mounted to the frame; and
a controller electrically coupled to the detector and to the display, the controller and programmed to detect a light signal from the detector and to increment the display upon each detected interruption of the light signal.

2. The device of claim 1, wherein the first upright and the second upright support the crossbar at a height between about 24 inches and 48 inches.

3. The device of claim 2, wherein the height is about 36 inches.

4. The device of claim 1, wherein the detector includes one or more of an electric eye, a retroreflector, a linear camera, or a 2-D camera.

5. The device of claim 1, wherein the first base and the second base each include one or more wheels.

6. The device of claim 1, wherein the distance between the first upright and the second upright is about six to about nine feet.

7. The device of claim 6, wherein the distance is about eight feet.

8. The device of claim 1, wherein the controller includes a wireless data connection to a remote console.

9. A method of counting tires entering or exiting a vehicle, the method comprising:
positioning a first upright adjacent a first side of a door to a vehicle and a second upright adjacent a second side of the door to the vehicle, wherein the first upright includes a light source, the second upright includes a light detector, the light source producing a light directed toward the light detector;
rolling a tire between the first upright and the second upright such that the tire interrupts the light;
incrementing a total for each interruption of the light; and
displaying the total on a display.

10. The method of claim 9, wherein the first upright and the second upright are connected by a crossbar disposed between 24 and 48 inches above the ground.

11. The method of claim 10, wherein the display is mounted to the crossbar.

12. The method of claim 10, wherein the first upright and the second upright each include a wheel, and wherein the step of positioning includes rolling the first upright and the second upright connected by the crossbar adjacent the door.

13. The method of claim 9, further comprising providing a camera to produce a video record of the counting operation.

14. The method of claim 9, further comprising transmitting the total to a remote console.

15. The method of claim 14, wherein the remote console includes a cellular phone.
